(19) United States
(12) Patent Application Publication
(10) Pub. No.: US 2024/0409216 A1
(43) Pub. Date: Dec. 12, 2024

(54) SEATING SYSTEM FOR AN AIRCRAFT

(71) Applicant: Ali Ersan, London (GB)

(72) Inventor: Ali Ersan, London (GB)

(21) Appl. No.: 18/697,640

(22) PCT Filed: Oct. 4, 2022
(86) PCT No.: PCT/EP2022/077560

§ 371 Date: Apr. 1, 2024

(30) Foreign Application Priority Data
Oct. 4, 2021 (GB) 2114210.4
Apr. 28, 2022 (GB) 2206217.8

(51) Int. Cl. B64D 11/06

(52) U.S. Cl. CPC B64D 11/0601; B64D 11/064; B64D 11/0641

(57) ABSTRACT

A passenger seating arrangement for an aircraft cabin is disclosed. A plurality of seat units each comprise at least a first reclining seat and a second reclining seat. The seat units are located in a column adjacent to a longitudinal aisle of the aircraft cabin. The first reclining seat and the second reclining seat of the seat units are configured to have substantially similar plan view contour and side-by-side alignment when similarly reclined. The seat units are angled to the aisle to provide a direct access from the aisle to the first and second reclining seats of the seat units. The seat units in the column are arranged in a staggered herringbone configuration relative to the aisle.

This disclosure generally relates to aircraft seating systems. More particularly, specifically arranged passenger seat units for an aircraft and method for operating the seat units are disclosed.

Seats in a passenger aircraft are typically arranged in longitudinal columns along an aisle. An aircraft can comprise one or two aisles. The number of aisles typically but not necessarily depends on the width of the aircraft body. A passenger aircraft can be divided into cabins, and include different cabin types, commonly called “classes”. Passenger aircrafts can be divided into economy and business class seating areas, or cabins. Other classes such as first class and premium economy may also be provided. The cabin types can be named differently by different aircraft operators. For clarity, in the following the cabins are divided between economy and premium class cabins, unless considered necessary to use more specific categorization of the classes.

An important difference between the cabin types is the level of passenger comfort. The cabin designs and features providing the differentiation can be significantly different in different classes. For example, in the economy class seats are commonly arranged in straight longitudinal columns of adjacent seats in rows with shared armrests, small if any tray like tables, relatively shallow backrest reclines (if any) and short pitch between the seat in the rows. In the higher, i.e., premium classes comfort is a much more important design factor. Typically, a premium class cabin has wider seats with deeper recline, even what is commonly called the lie flat capability and overall feeling of more space and comfort. Additional comfort increasing features can also be provided, such as footrests, fixed and/or bigger tables, storage space, monitors and so on.

Deeper recline, greater pitch between the seats and wider seats takes more space. This limits the number of seats. Auxiliary comfort increasing equipment such as fixed tables, TV monitors and personal storage space further eats into the limited space within the aircraft. Various seating designs have therefore been proposed to optimise the use of the limited space. A common solution is to angle, e.g., the business class and premium economy seats relative to next seats and the aisle and stagger the seats in the column so that more deep reclining seats can be provided in the available space compared to seats that are lined in straight rows normal to the aisle.

Further improved use of the space while still offering premium class comfort may be desirable. This can be especially desirable on single aisle aircraft cabins. The herein described examples aim to address one or more of issues relating to premium class type seating systems.

According to an aspect there is provided a passenger seating arrangement for an aircraft cabin, comprising: a plurality of seat units each comprising at least a first reclining seat and a second reclining seat and located in a column adjacent to a longitudinal aisle of the aircraft cabin, wherein the first reclining seat and the second reclining seat of the seat units are configured to have substantially similar plan view contour and side-by-side alignment when similarly reclined, the seat units are angled to the aisle to provide a direct access from the aisle to the first and second reclining seats of the seat units, and the seat units in the column are arranged in a staggered herringbone configuration relative to the aisle.

According to an aspect there is provided a passenger seating arrangement for an aircraft cabin, comprising a plurality of seat units each comprising at least a first reclining seat and a second reclining seat and located adjacent to a longitudinal aisle of the aircraft cabin, wherein the first reclining seat and the second reclining seat of the seat units are configured to have substantially similar plan view contour and side-by-side alignment when similarly reclined, the seat units are angled to the aisle to provide a direct access from the aisle to the first and second reclining seats of the seat units, and the seat units are in a configuration where two successive seat units in a column are about normal relative to each other.

According to an aspect there is provided a passenger seating arrangement for an aircraft cabin, comprising four seat units located adjacent to a longitudinal aisle of the aircraft cabin, wherein two seat units are in a first column and two seat unit are in a second column, each seat unit comprises at least one reclining seat, the seat units are angled to the aisle to provide access from the aisle to the at least one reclining seat of the seat units, and the four seat units are arranged in about a X-shaped configuration to provide a group seating area.

According to yet another aspect there is provided a method for a passenger seating arrangement in an aircraft cabin wherein a plurality of seat units is located in a column adjacent to a longitudinal aisle of the aircraft cabin and comprise seat units arranged into the aircraft cabin as described herein, the method comprising moving a first reclining passenger seat and an adjacent second reclining passenger seat relative to each other between an upright position and a reclined position while maintaining a side-by-side alignment between the first and second seats when similarly reclined.

In accordance with a more detailed aspect the reclined position of the first and second reclining seats provides a lie flat configuration. The first and second reclining seats may be arranged to provide a double bed style configuration in the lie flat position.

The first reclining seat and the second reclining seat of the seat units can be independently moveable relative to each other between an upright position and a fully reclined position. The plan view of the second reclining seat in the fully reclined position may be arranged to be a mirror image of the first reclining seat in the fully reclined position.

The second reclining seat of the seat units can be located closer to the aisle than the first reclining seat, the difference in the distance to the aisle being defined by the angle of the seat unit to the aisle.

The first and second reclining seats can be arranged in a substantially parallel configuration in the seat unit. Alternatively, the first and second passenger seats may be modestly angled relative to each other in the seat unit. The angle between the seats can be up to 25 degrees.

The angle between the seat units and the aisle measured as an angle between the centre line between the two reclining seats and the centre line of the longitudinal aisle can be within the range of 20-50, preferably 30-50 degrees.

Seat units in a column of staggered seat units comprising the first and second reclining seats may be nestled.

A separate egress may be provided for each of the first and second seats of the angled seat units for the direct access to the aisle. The seat units may comprise doors in the separate egresses for to the first and second reclining seats.

A shared egress for the first and second reclining seats of the seat units may be provided for access to the aisle.

Shape of at least one corner of the seats may be formed in dependence of the positioning of the seat units relative to the cabin walls and/or the aisle.

Two successive seat units in a column can be arranged into about normal relative to each other. The seat units can form a group seating area. Moveable divider may be provided between the two successive seat units. Direct access may be provided between the two successive seat units without need to enter the aisle.

The invention will become more fully understood from the detailed description of certain examples and the accompanying drawings, in which:

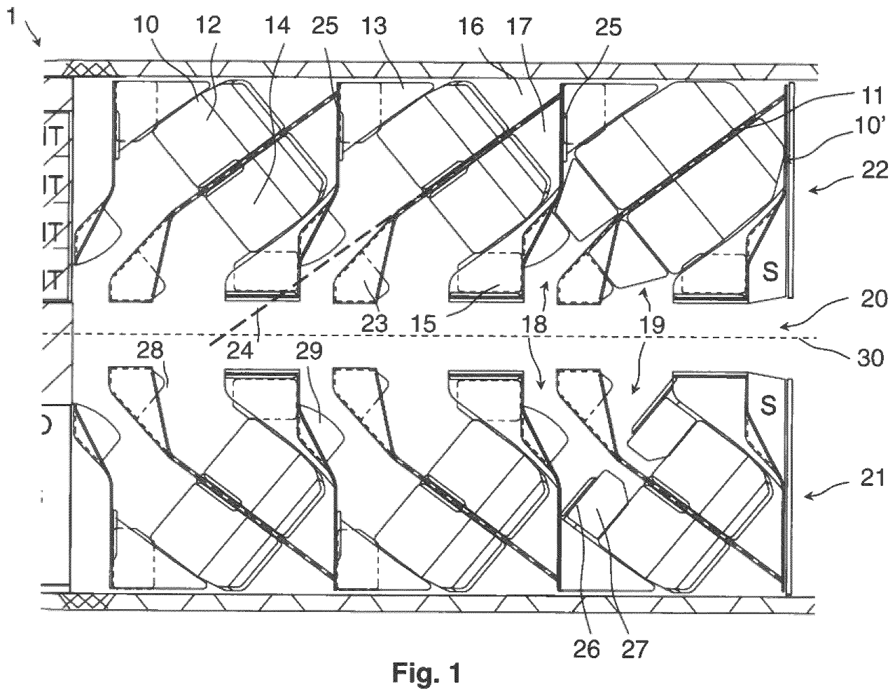

FIG. 1 is a top plan view of an example of a single aisle cabin with double seat units arranged according to the herein disclosed principles;

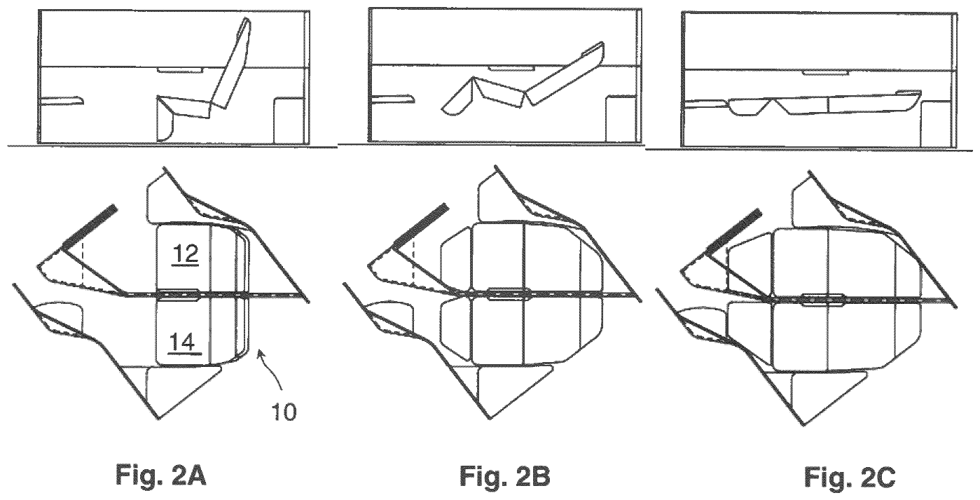

FIGS. 2A, 2B and 2C show views of an exemplifying seats in different positions;

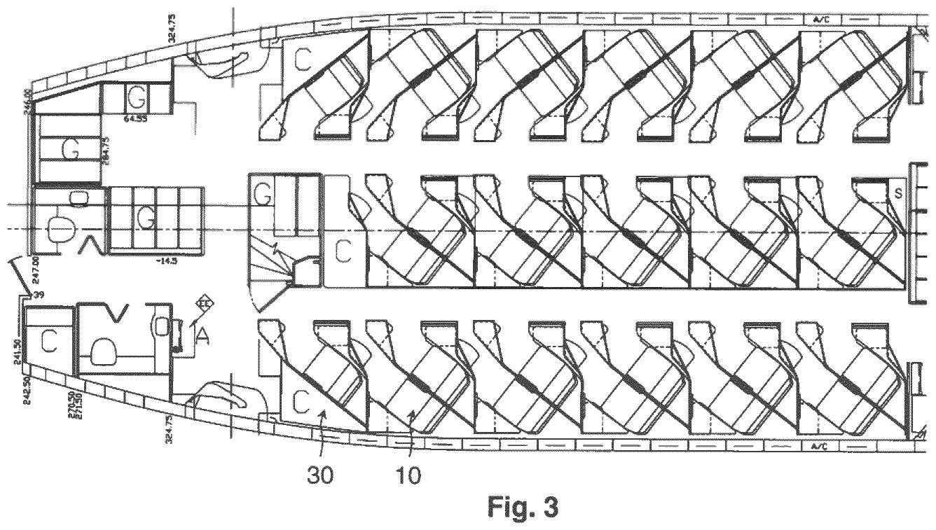

FIG. 3 is a top plan view of an example for a seating system of a two aisle cabin;

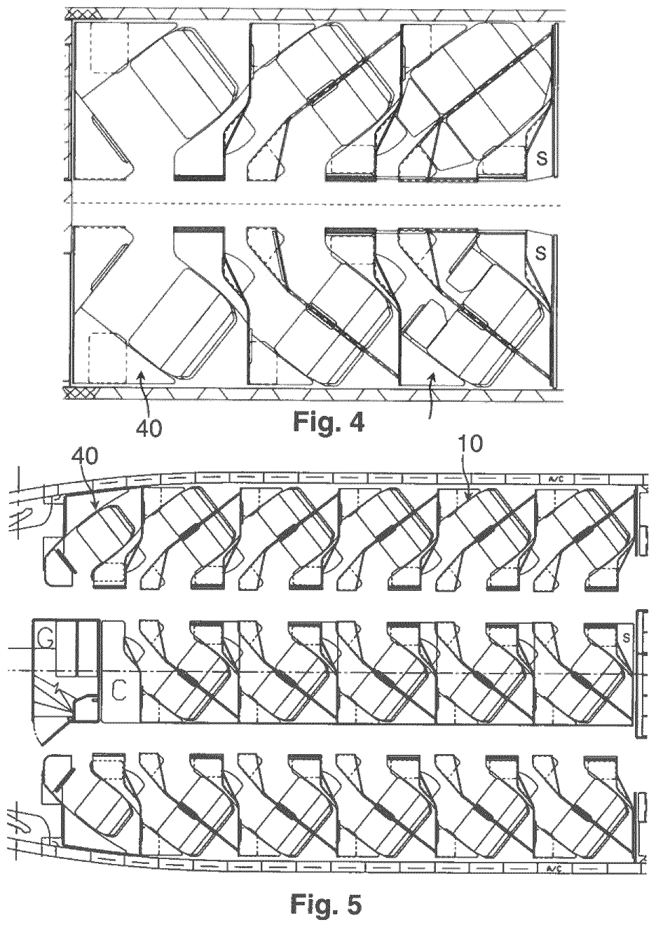

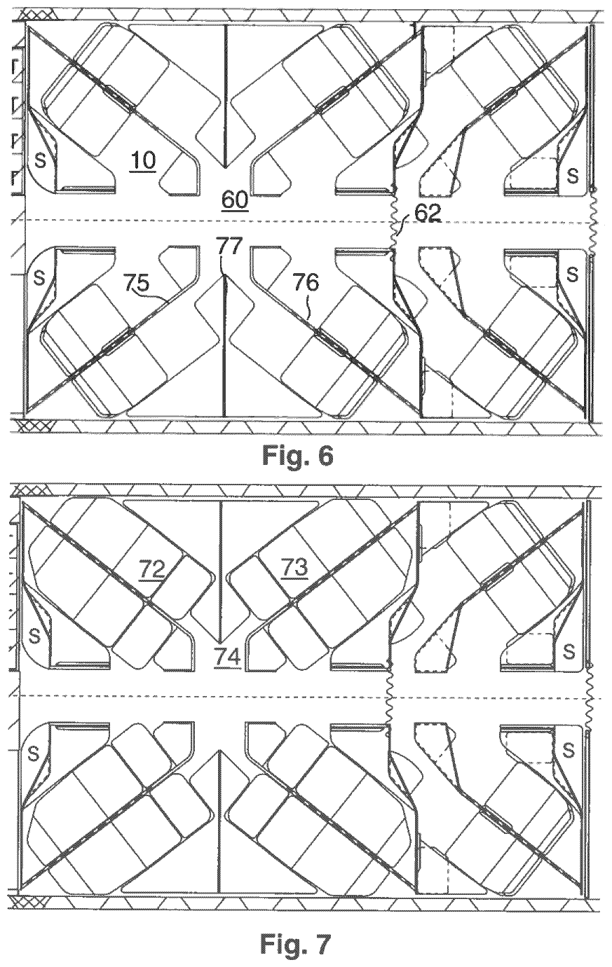

FIGS. 4 and 5 are schematic presentations of further examples;

FIGS. 6 to 10 are schematic presentations of examples of group seating arrangements;

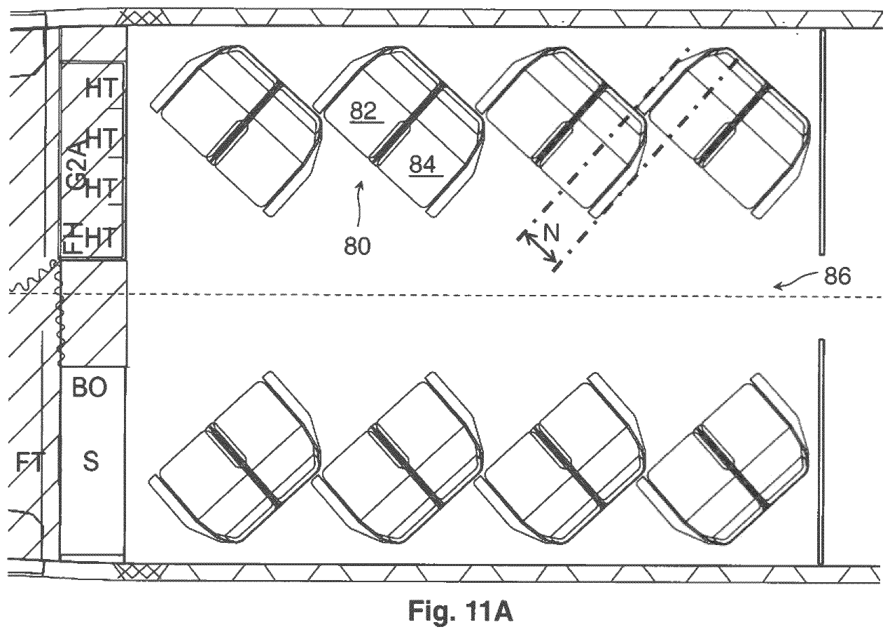

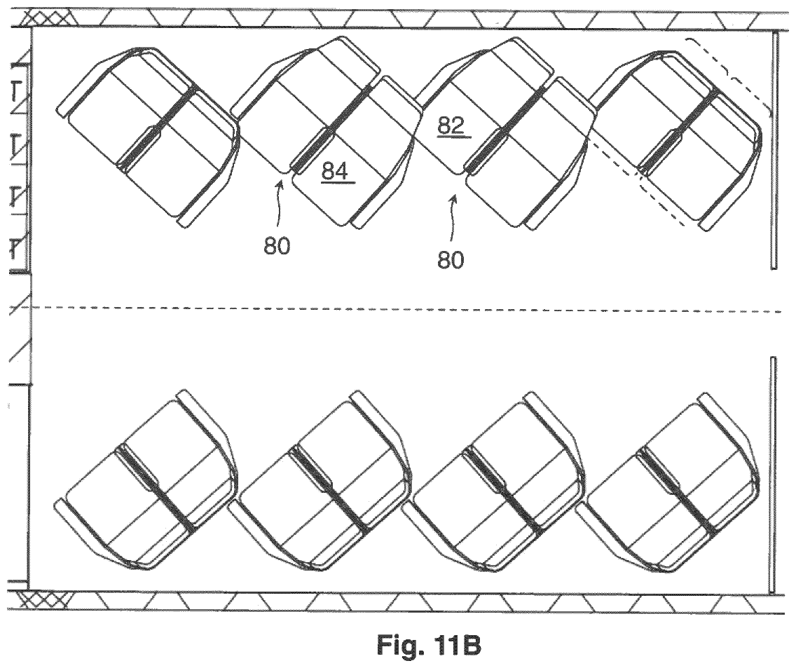

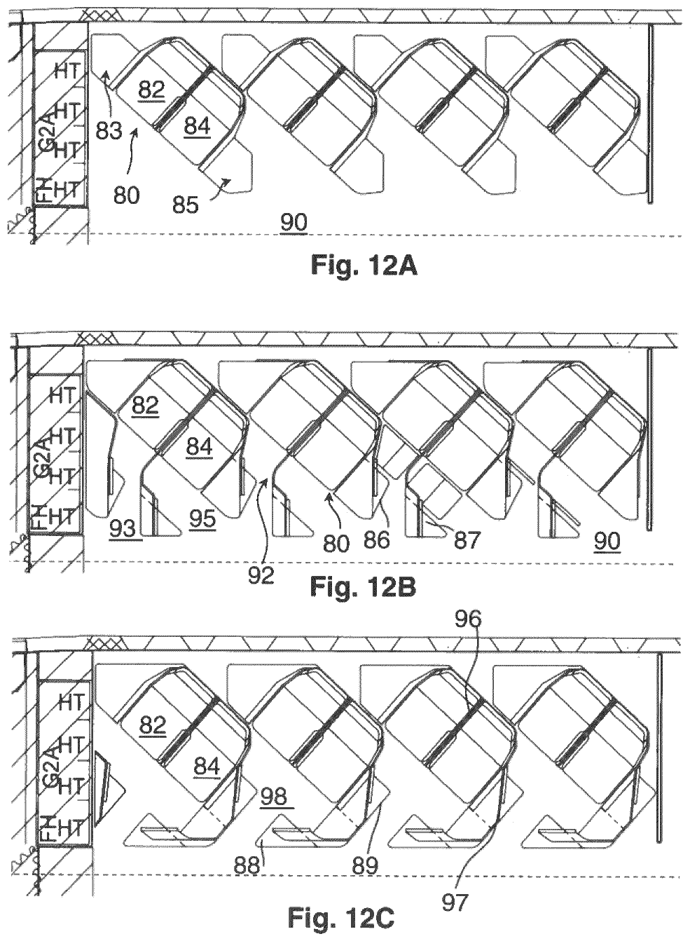

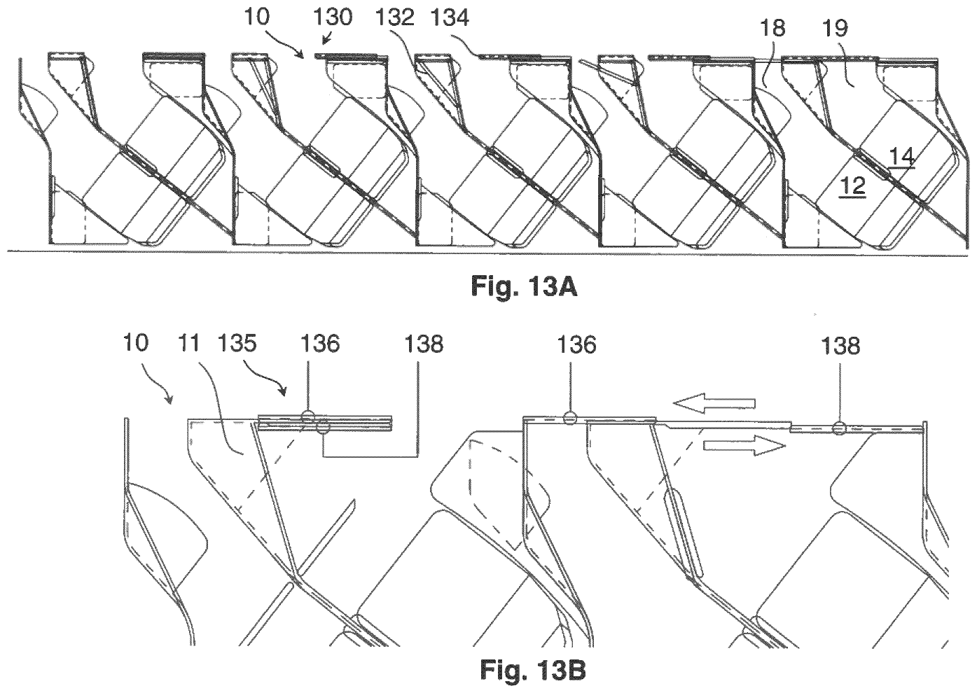

FIGS. 11A, 11B, 12A, 12B, and 12C are schematic presentations of further examples of double seat units;

FIGS. 13A and 13B are schematic presentations of door mechanisms for double seat units;

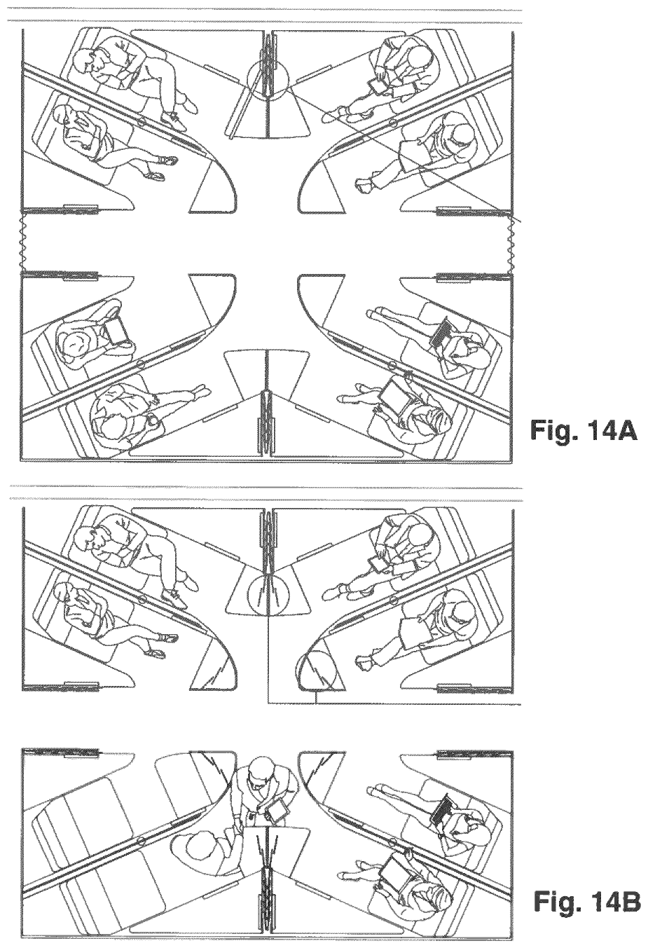

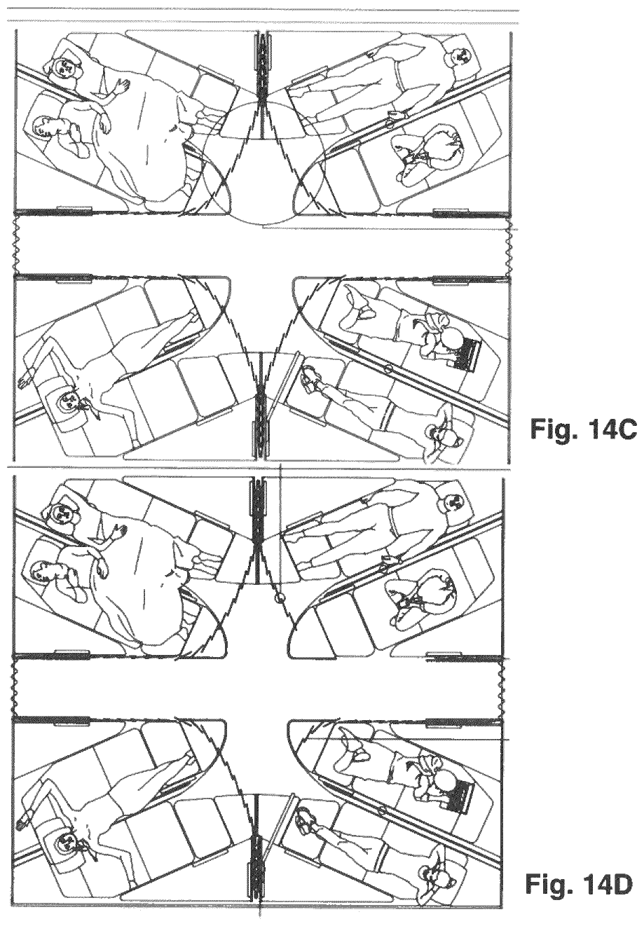

FIGS. 14A, 14B, 14C and 14D show top plan views of a partition arrangement in different operation positions;

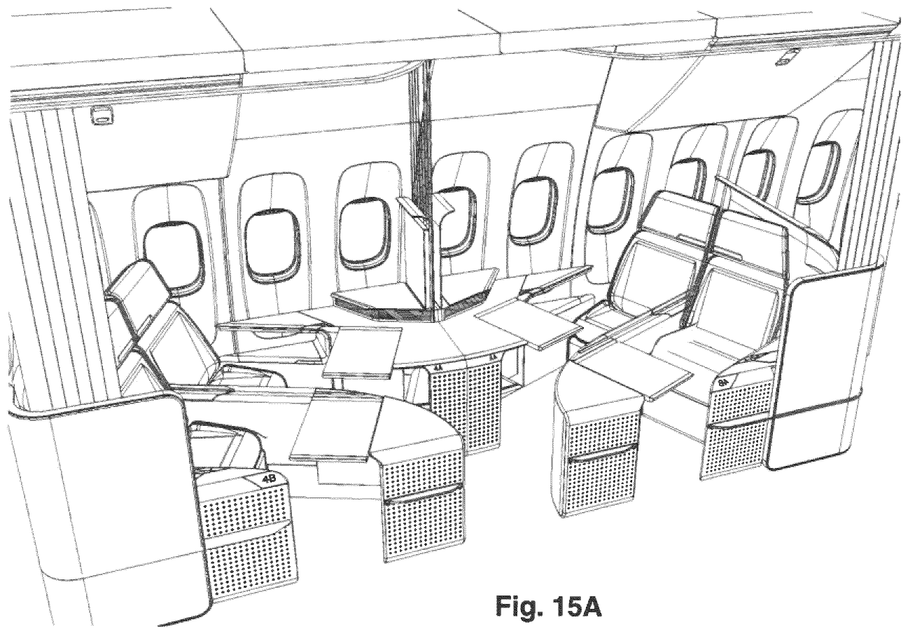

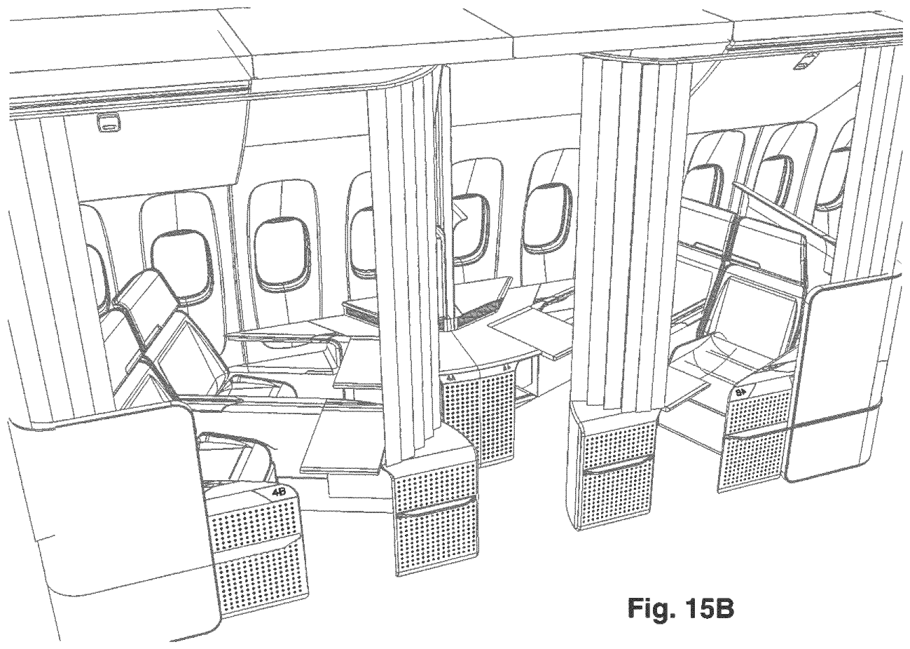

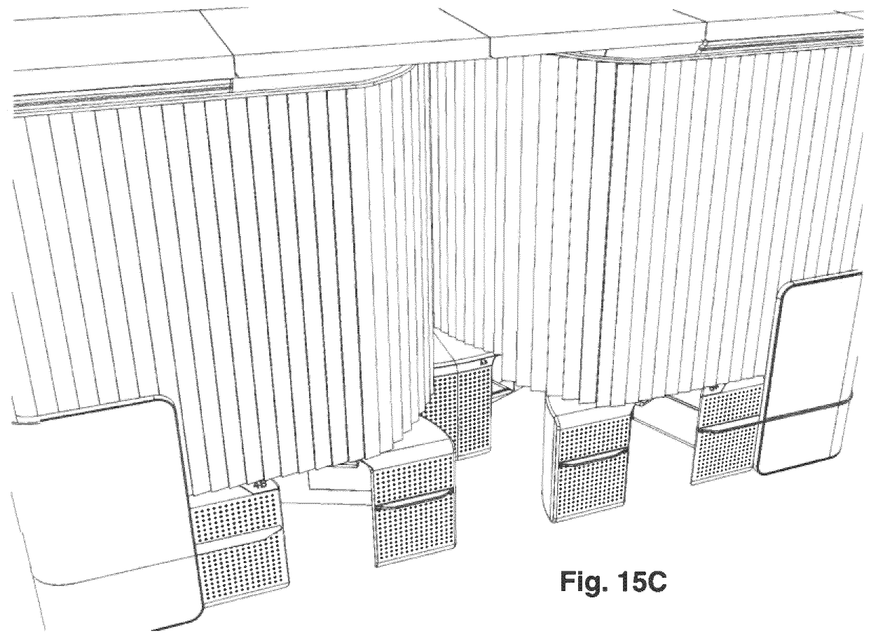

FIGS. 15A, 15B and 15C are views of a hanging partition arrangement in different operational positions;

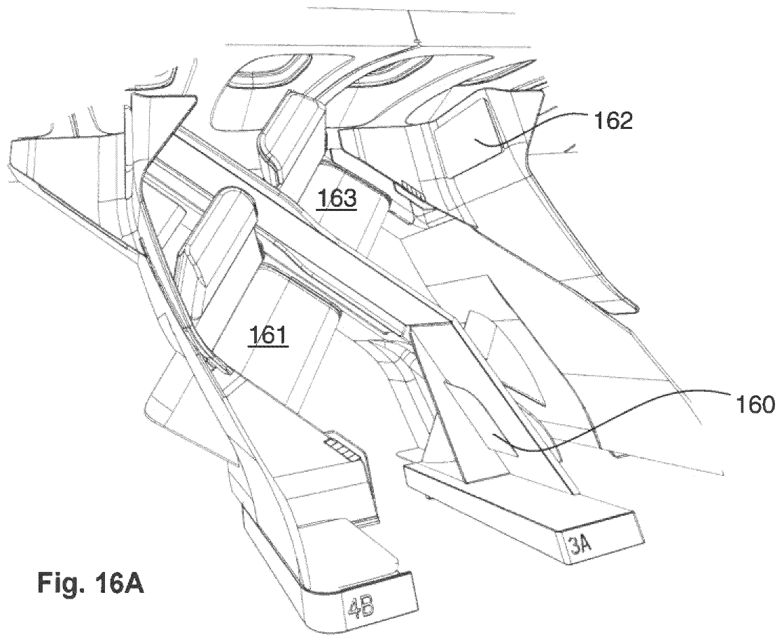

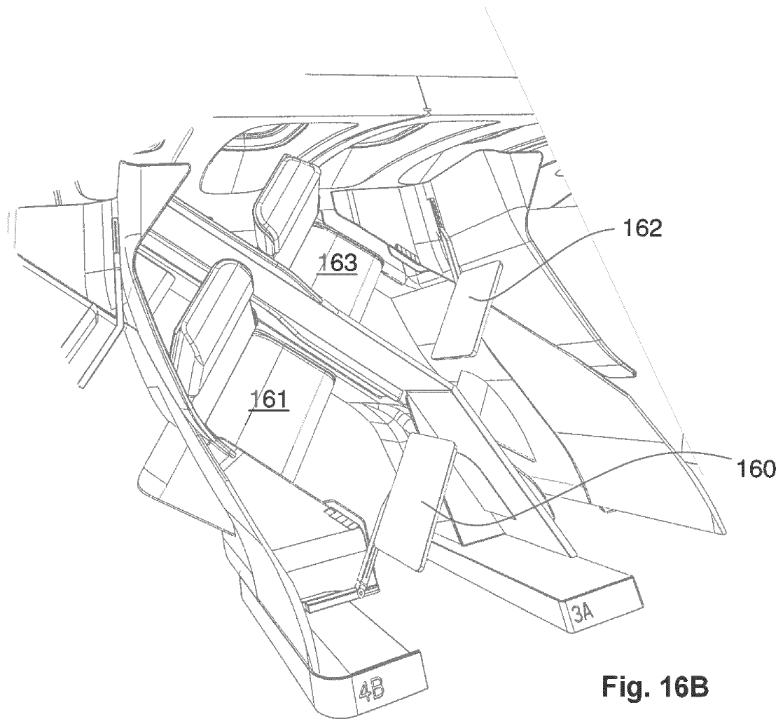

FIGS. 16A and 16B show an arrangement of display monitors;

FIGS. 17A and 17B are schematic presentations of possible angular relations of the seats of a seat unit;

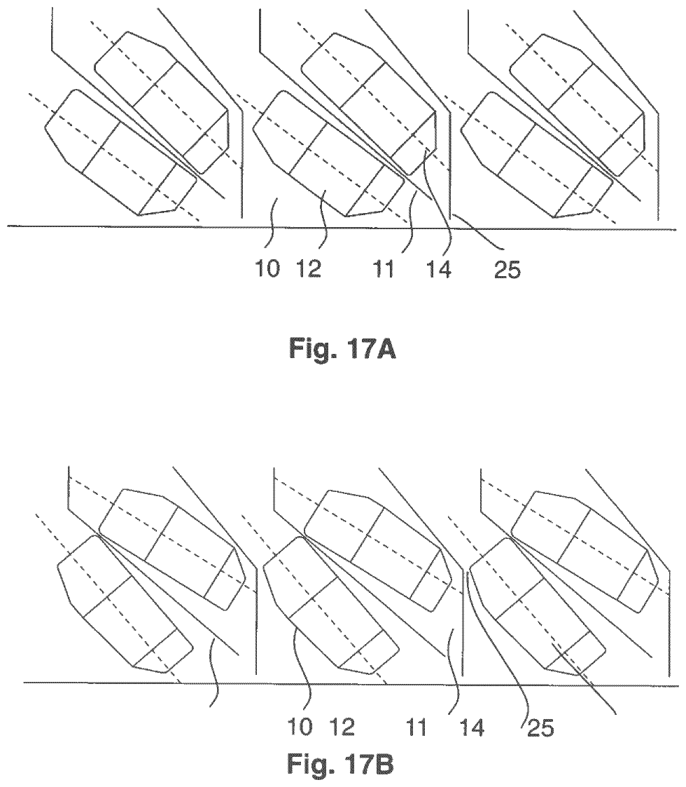

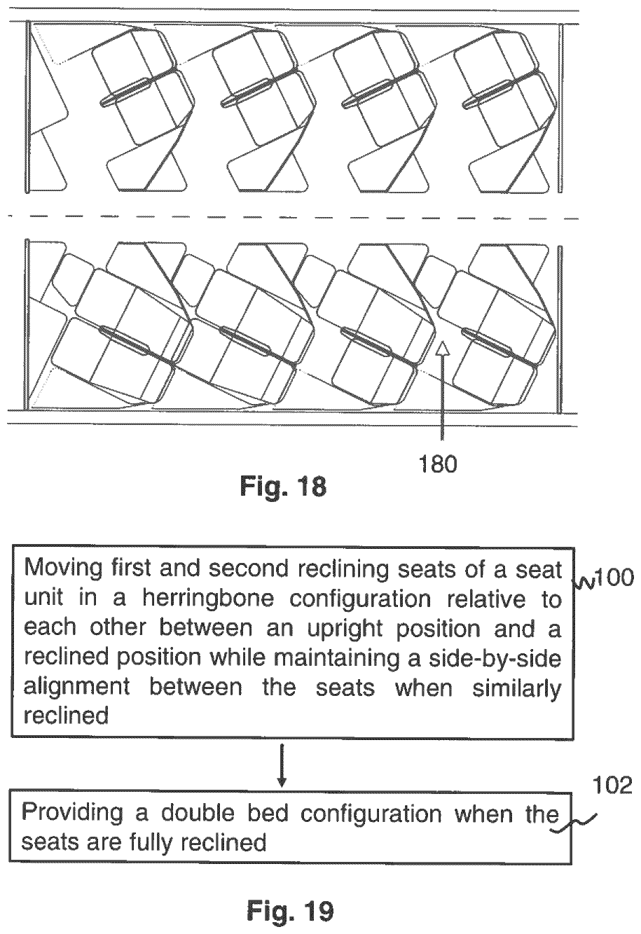

FIG. 18 shown a further example; and

FIG. 19 is a flow chart of a method according to an example.

The following description gives an exemplifying description of some possibilities to practise the invention. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

The following describes with reference to the appended drawings certain detailed examples for specific arrangements of seat units that can be assembled into an aircraft cabin. A seat unit comprising at least two aligned passenger seats is also described. The herein described principles and features can optimise use of floor space on an aircraft. Certain embodiments can increase passenger comport, especially for passengers travelling together or in groups.

FIG. 1 shows a schematic plan view of a passenger seating system for a cabin 1 of a single aisle 20 aircraft in accordance with an example. The seating system comprises a plurality of seat units 10 located in right hand column 22 and left column 21 on either side of the single longitudinal aisle 20 extending through the cabin 1. In this example the cabin 1 has six double seat units 10 providing twelve passenger seats. The seat units 10 each comprise a first reclining seat 12 and an adjacent second reclining seat 14. The two reclining seats 12, 14 are moveable between an upright position and a reclined position. In the FIG. 1 example all seats in column 21 to the left of the aisle 20 are in upright position. The seats of the last or back seat unit 10′ in column 22 to the right of the aisle 20 are in a fully reclined position.

A stowable privacy divider 11 can be provided between the first and second seats 12, 14 of a seat unit. The divider can be fully stowable, e.g., can be fully lowered between the seats, or partially stowable. Some of the auxiliary furniture such as table 23 and ottoman 28 may be provided in association with the privacy divider 11.

The seat units 10 are separated by walls 25. These can be of relatively fixed construction. Auxiliary furniture such as tables and storage places can be provided in association with the separating walls 25. For example, passengers on the “window seats” 12 can be provided with personal space/table 13. Passengers on the “aisle seats” 14 can use personal space/table 15. Passengers on both seats can have additional storage places 16 and 17 at the head ends of their seats. Ottomans 29 for the “window seat” passengers can also be provided in connection with the separating structure 25. Further furniture such as monitors 26 and tray tables 27 that can be moved away can be provided as a part of the structure defining the seat unit.

The reclining of seat can be arranged to provide a lie flat configuration, as shown by seat unit 10′ in FIG. 1. The two seats of the seating unit can be reclined independently from each other over a reclining range between the extreme reclining positions of upright and lie flat. The concept of reclining passenger seat and different possibilities for the mechanisms enabling the movement are well known and therefore are not explained in detail here.

FIG. 1 shows that the first passenger seat 12 and the second passenger seat 14 of the double seat units 10 are configured to have substantially similar plan view contour in the reclined and upright positions. This can apply to the seats over the entire reclining range. Examples for different detail of the contour such that the available space can be efficiently and/or flexibly used will be explained later in this description.

The first passenger seat 12 and the second passenger seat 14 are arranged into a side-by-side alignment with each other in all positions, i.e., when similarly reclined or upright. Examples of the seats in different positions are shown by the side and top plan views of a double seat unit 10 in FIGS. 2A-2C. FIG. 2A shows both seats 12, 14 in upright position. FIG. 2B shows both seats in an intermediate or “lazy Z” position. FIG. 2C shows both seats 12, 14 in full flat position. In the example of FIG. 2C flight compensation has been applied to the seats and thus the seats are not full horizontal. The compensation can be, e.g., 1 to 4 degrees. As illustrated by the top plan and side views, the seats 12, 14 of the seat unit 10 are in complete alignment when similarly reclined.

The aligned first and second seats 12, 14 of the seat units 10 can also be arranged to provide double bed style configuration when reclined into the lie flat position. This may be desired by couples or family members flying together. The divider between the seats can be removed, for example lowered down between the seats entirely or partially. In the latter alternative a feet end part of the divider may be fixed. A head end part may be arranged to slide or otherwise be stowed away next to the feet end part.

The alignment of the seats is facilitated by staggering the seat units 10 instead of staggering the individual seats 12, 14 in the columns. The staggering of the seat units 10 provides a herringbone configuration of the seat units 10 relative to the aisle 20 whereas the seats of the seat units are not in herringbone formation. The first passenger seat 12 of the seat unit 10 is located further from the aisle than the second passenger seat 14. The difference in the distance from the aisle to the set depends on the angle of the seat unit. The angling of the staggered seat units 10 to the aisle 20 is indicate by the dashed line 24, the first seat 12 and the second seat 14 being correspondingly angled to the aisle 20.

Passenger seats 12, 14 are provided with direct access to the aisle via respective egresses 18 and 19. The term direct access refers herein to an access arrangement where inconvenience of so called stepover on next passenger can be avoided. The egresses can be provided per individual seat of a seat unit. Examples of individual egresses are shown in, e.g., FIGS. 1, 2 and 3.

A shared egress can also be provided in certain types of seat units. An example of this is shown in FIG. 12C. A mix of individual and shared egresses can be provided in a column and/or cabin.

The angle is designed such that it enables direct access paths 18, 19 to the aisle from both seats. According to an example, measured between the centre line 24 of the seats and the centre line 30 of the aisle, the angle can be in the range of 30 to 50 degrees. According to a specific example the angle is 38 degrees.

The alignment of the seats 12, 14 within the staggered seat units 10 enables more efficient use of the space. A reason for this is that the last seat unit 10′ in the column 22 can be positioned closer to the back end of the cabin 1 than would be the case if the seats would be arranged in a herringbone as that would need to be taken further back. The alignment of the seats can also be desirable by passengers travelling together.

FIG. 1 plan view also illustrates an example how the contours of the feet rests at the at the feet ends and of the back rests at the head ends of the seats 12, 14 can be shaped to efficiently use the available space in the cabin 1. In this regard a reference can also be made to the arrangement of the seat units 10 and contours of the seats in FIGS. 6 and 7. At Is some corners of the seat element can be shaped based on the angle on which the element faces cabin structures such as the side and middle wall, the aisle, and the dividers.

The space can be used even more efficient if the seat units are arranged in a nestled configuration, an example of which is shown in FIG. 11.

The seat can be configured to have pitch (the distance between similar point on adjacent seat units) in the range 40 to 70 Inches/101 to 178 cm. In accordance with a specific example the pitch is about 60 inches/152 cm per the two seats of a seat unit. Width w of each passenger seat, can be in the range of seat pan widths from 17 to 40 inches/43 to 101 cm.

FIGS. 1 and 2C illustrate how the plan view of the second passenger seat 14 in the reclined position can be a mirror image of the first passenger seat 12. This can be advantageous in optimising the use of space in the corner areas of the seat unit 10. The contours of the seats can be designed to further optimise and/or facilitate more flexible use of the available space in the cabin, for example as shown in the FIGS. 1, 4, 6 and 7. The mirroring provides further advantage in allowing manufacture of one design, even if in a mirror image, for all the seats.

FIG. 3 shows an example of a twin aisle cabin comprising three columns of staggered seats units 10. In general, the seat units can be arranged in each column as described with reference to the single aisle cabin.

FIG. 3 shows further the possibility to have different seat units, in the example single seat units 30, in a column. This can be advantageous, e.g., at the end of a column.

FIGS. 4 and 5 shows other examples where at least one of the seat units in a column is different from the two seat units 10. In these examples the first rows are occupied by first class seats 40.

FIGS. 6 to 10 shows examples where a group or family section is provided by an arrangement of seat units into about normal angles to each other. It is noted that the about normal is not intended to be limited to exactly 90 degree but rather refers to angles like the X-shaped configurations shown in the figures.

FIG. 6 shows a plan view of the seats of the seat units 10 in upright position. FIG. 7 shows a plan view of the seat units in double bed configuration. In FIGS. 6 and 7 four double seat units 10 are arranged in a four-point star shaped, i.e., X-shaped configuration over two of the columns to provide a group section 60 at the front end of the cabin on a single aisle aircraft. The furniture in the middle can be arranged to be on a relatively low level so that the members of the group have a good visibility of each other. In the bed configuration seats 72, 73 reclined in lie flat position may share the egress 74. Need for this depends on the furniture and the way the dividers 75 and 76 are designed. An additional divider 77 can be provided between the double bed seat units 10. All dividers 75, 76 and 77 can be stowable. For example, in X-shaped configuration of four flat beds in a family zone the centre screen or divider 77 between two double beds can fold away, and there can be a flexible arrangement of three dividers that can be folded away. Moveable divider 77 between the double seat units in a column makes it possible to move from one double bed unit to the another without accessing the main aisle in a family or group zone.

The group section can be separated from the rest of the cabin by a curtain 62. The remainder of the cabin can comprise seats units 10 in the herringbone configuration as described above. The location of the X-shaped group of four seat units can be anywhere in the cabin. Also, more than one such group can be provided. It is also possible to have just two double seat units angled about normal to each other in one column.

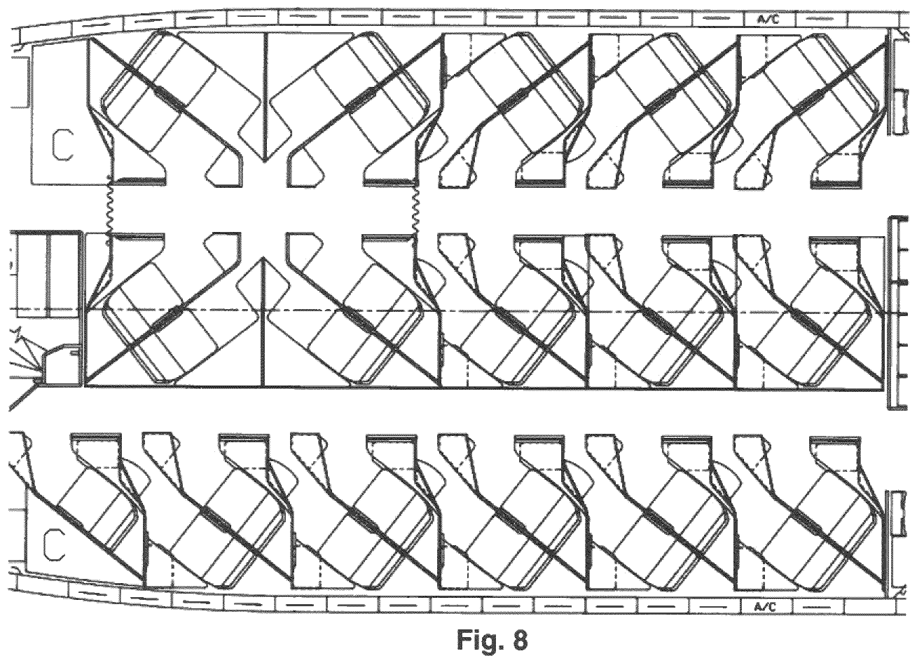

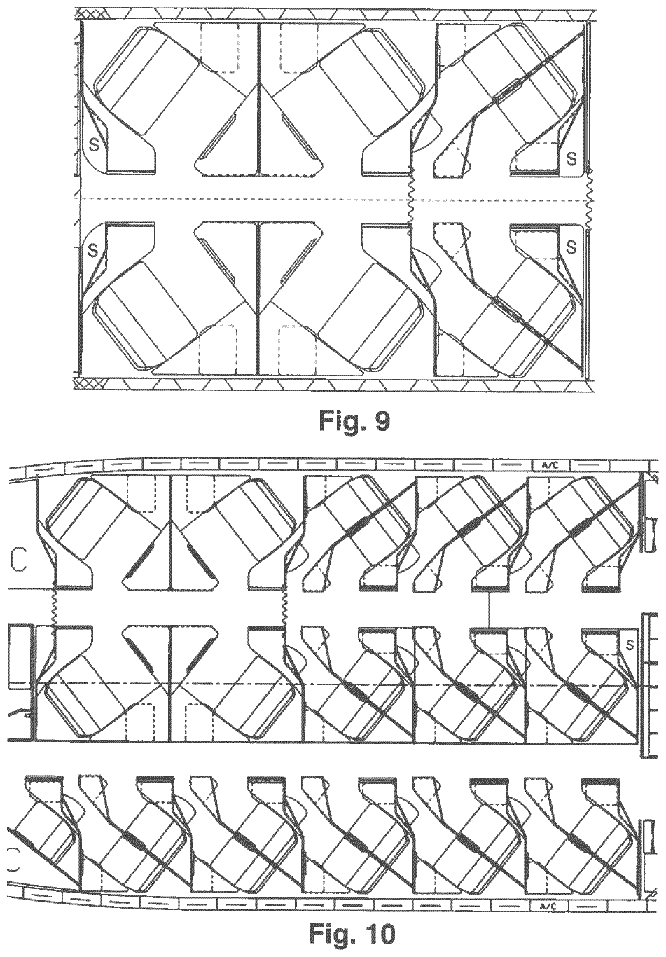

FIG. 8 shows an example where four double seat units are grouped into about star shaped relation to each other on a twin aisle aircraft. FIGS. 9 and 10 show examples where first-class seat units are grouped into about X-shaped relation to each other on a single aisle aircraft and a two aisle aircraft, respectively.

Communications between members of a group can be improved by a system of headsets connected to each other to a form a network of communication devices for group communications. The communications may be provided through the wired audio system of the aircraft. The network may also be provided wirelessly based on appropriate wireless standards and/or close range radio protocols. For example, Bluetooth™ or some WiFi based short range radio system may be used for the group communications. This can provide enhanced comfort and experience for a family or another group in the group zone. Other group interaction features are also possible. For example, the furniture can be arranged to enable member to dine together.

Instead of fully reclining seats, i.e., lie flat seats it is possible to use staggered seat units in herringbone configuration comprising only partially reclining seats. Such configuration can be used for example for what is commonly called as Premium Economy class. FIG. 11A shows a plan view of an example of a basic arrangement of such double seat units 80 in a single aisle cabin where the partially reclining seats 82 and 84 are in the upright position. FIG. 11B shows the seats of two seats units 80 in the right column in reclined position. The staggering facilitates direct access for both seats 82 and 84 to the aisle 86.

FIGS. 11A and B also shows an example of the nestled arrangement of the seat units. The amount of nestling is indicated in FIG. 11A by the distance N between the dashed lines. A passenger occupying seat 82 can use the space underneath the slightly partially overlapping reclined seat 84. As shown in FIG. 11B, even when reclined there is not that much overlap and seat 84 in the front does not extend too much into the space of the passenger on the seat 82 behind. The restricted recline prevents the seat back of seat 84 from landing too close to the seat pan of seat 82. Accepting some nestling also allows for more flexibility in designing the cabin layout and placing of auxiliary equipment.

FIG. 11B also shows, in dashed lines in front and back of the last seat unit in the right column, how the seat pan can move forward, for example about 3 inches/8 cm and as the back seat reclines.

FIGS. 12A-12C show examples for additional features of the seat units of FIG. 11. In the FIG. 11A plan view of one column of seats units 80 comprising furniture such as side tables 83 and 85. As shown, there is sufficient space for reasonably sized side tables for both seats of the seat unit without blocking the direct access from the window seat 82 to the aisle 90.

FIG. 12B shows a plan view of seat units 80 in a column where privacy dividers 92 are provided between seats 82 and 84 and separation dividers 94 are provided between the seat units. Each seat 82 and 84 has its own egress 93 and 95 for direct access to the aisle 90. The dividers 92 between the seats are at least in part moveable so that at least a part thereof can be stowed away to enable interaction and privacy as desired. Ottomans 86 and 87 are also provided for seats 82 and 84, respectively. Ottomans 86 are provided in connection with the privacy divider elements 92. Ottomans 87 are provided in connection with the separation divider elements 92.

FIG. 12C shows a variation of the divider arrangement where the seats of the seat units are separated by dividers 96 and the seat units are separated by more substantial separation dividers 97 than in FIG. 11B. A common egress 98 is provided for the passengers in a seat unit with separation divider 97 between the seat units for the direct access to the aisle. Ottomans 88 and 89 are also provided for the seats 82 and 84, respectively. In this example both ottomans 88 and 89 are provided in connection with the separation divider elements 97.

FIGS. 13A and B illustrate in plan views examples of door mechanisms than can be provided in an access path to a passenger seat.

FIG. 13A shows stages of closing the doors from left to right. On the left is a seat unit 10 where parts of a door mechanism 130 are stowed away. On the right hand seat unit the doors are fully deployed and the seats 12 and 14 enclosed into their own compartments. The door mechanism 130 comprises two door units 132 and 134. Part 132 is stowed in connection with the divider between the seats. Door part 134 is stowed in connection with the partition between the seat units. Part 132 swivels out of the divider to close egress 18. Part 134 slides from the side of the partition to close egress 19.

FIG. 13B shows an example of a door mechanisms 135 where doors 136 and 138 for both egresses are stowed in connection with the divider 11 between the seats of the seat unit 10. The left seat unit has both doors 136 and 138 in stowed position. The right seat unit has both doors 136 and 138 slid into their deployed position. The sliding movement is indicated by the respective arrows. Such sliding door arrangement can also be provided in association with the other types of seating units described herein and also for enclosing single seats. For example, the sliding doors can be provided in connection with seats arranged in herringbone configuration.

FIGS. 14A, 14B, 14C and 14D show top views of partitions or dividers 140 in different operational positions. FIGS. 15A, B and C show perspective views of partitions comprising hanging slates 142.

In FIG. 14A partition 140 is shown to be stowed away in two stowage locations 144 and 145. FIG. 14B shows the partition in a partially deployed position to provide some privacy. FIG. 14C shows the partition in a fully deployed position. In this example each of the two seat seating units 10 can be flexibly separated into a private space.

FIG. 14D shows how one seat of a pair of seats can be separated into a private mode by partition 143 while partition 144 of the other seat of the pair of seats 10 is in the stowed position.

FIGS. 14C and D also show how a single person 145 can occupy a double bed provided by a twin seat unit, and privacy portioning of the seat unit.

The views of FIGS. 15A, B and C shows examples how a partition can be configured to comprise slates 142. The tops of the slates can be attached to ceiling mounted rails, wall mounted rails or otherwise supported rails so that that the slates of the partitions can be easily pulled out from and moved back into the stowed positions. The slates can also be arranged rotatable about vertical axis for quick opening and closing when fully or partially deployed.

FIG. 15A shows the slated partitions in the stowed away position, corresponding to FIG. 14A. FIG. 15B corresponds to FIG. 14B in showing the partially pulled out partitions. In this position the slates do not have to be rotated in the closed position. That is, the slates can be open or closed. FIG. 15C shows fully expanded partitions while the slates are closed. The slates can be rotated between open/see through position and the closed position. The slates can be rotated into the closed position to provide privacy. The slates may be arranged to slightly overlap in the closed position.

The slates can be of relatively rigid material, for example plastic. Fabrics may also be used. The partitions can be formed of anything from a soft textile to a relatively rigid material. The slates can be independent and/or connected like a concertina. Each slate can be connected to the adjacent slates. The bottoms of the slates can be provided with stabilising members, for example weights, magnets, connecting cables or chains to prevent the slates swaying, e.g., because of turbulence. An advantage of a late like structure is that it provides extra security feature for emergency situations, as the passengers can exit their seats by pulling the slates separate, i.e., through the “slate wall” without trying to open a rigid door and/or any latches or the like.

A hanging partition can also comprise a one-piece structure, for example a curtain.

FIGS. 14 and 15 show the hanging partition structure in the X-shaped group seating configuration. Hanging partitions can be provided in association with the other types of twin seat seating units described herein. Hanging partitions can also be provided for enclosing a single seat unit and other types of twin seat units, triple seat units and so forth.

FIGS. 16A and 16B show and example of a monitor assembly. FIG. 16A shows a monitor 160 in a first or portrait orientation at one side of a seat 161. FIG. 16B shows the monitor 160 deployed in a second or landscape position and pulled in front of the seat 161 and thus the passenger. In the portrait position the monitor can be in a passive state, displaying, e.g., announcements and travel information. The monitor 161 can be turned into landscape position where the monitor 161 is more actively viewed. For example, the motor can be turned into landscape for the purposes of watching in-flight entertainment such as a movie. The orientation of the displayed view can be changed automatically as the monitor is turned between the different orientations. A similar monitor 162 can be provided for seat 163.

A larger monitor can also be provided between seats 161 and 163. The larger monitor can be folded away and/or turned between portrait and landscape positions. When in landscape position the larger monitor screen can be viewed from both passenger seats 161 and 163. The double seat unit may comprise the two smaller monitors 160, 162 and a larger central monitor.

The above explained flexible monitor arrangements can also be provided in connection with other types of seat units, for example in connection with a single seat unit and seat units in herringbone configuration.

In the above explained Figures the first and second passenger seats of a double seat unit are arranged substantially parallel to each other. It is also possible to have a double seat unit with seats that are slightly angled relative to each other. FIG. 17A shows a schematic example of a modestly angled arrangement of seats 12 and 14 of seat units 10 separated by dividers 25. In this example the head ends are slightly separated from each other. FIG. 17B shows an example where seats 12 and 14 of seat units 10 separated by dividers 25 are angled such that there is a gap at the footrest ends. Stowable privacy divider 11 can extend about in the middle of the widening divisions. The angle between the centre lines of seats (denoted by the dashed lines) can be, for example up to 25 degrees in both examples.

FIG. 18 shown an example of a possible configuration where the window seat is provided with direct access to the aisle only when the aisle seat is not in fully reclined position. In the full lie flat position of the aisle seat a step-over configuration may be needed. This is pointed out by arrow 180.

FIG. 19 is a flowchart for operating a seat unit as described herein. In the method a first reclining seat and an adjacent second reclining seat are moved at 100 relative to each other between an upright position and a reclined position while maintaining a side-by-side alignment between the first and second seats when similarly reclined. As explained above, the seat units and not the seats are in herringbone configuration. In 102 a double bed configuration can be provided when the first and the second seats are fully reclined.

The foregoing description provides by way of exemplary and non-limiting examples a full and informative description of exemplary embodiments of the invention. While certain aspects of the invention may be illustrated and described as schematic pictorial representation and flow charts, it is well understood that these blocks, systems, techniques and methods described herein may be implemented in various manners. Therefore various modifications and adaptations may become apparent to those skilled in the relevant arts in view of the foregoing description, when read in conjunction with the accompanying drawings and the appended claims. All such and similar modifications of the teachings of this invention will still fall within the spirit and scope of this invention.

1. A passenger seating arrangement for an aircraft cabin, comprising:
a plurality of seat units each comprising at least a first reclining seat and a second reclining seat and located in a column adjacent to a longitudinal aisle of the aircraft cabin, wherein
the first reclining seat and the second reclining seat of the seat units are configured to have substantially similar plan view contour and side-by-side alignment when similarly reclined,
the seat units are angled to the aisle to provide a direct access from the aisle to the first and second reclining seats of the seat units, and
the seat units in the column are arranged in a staggered herringbone configuration relative to the aisle.

2. The passenger seating arrangement of claim 1 wherein the reclined position of the first and second reclining seats provides a lie flat configuration.

3. The passenger seating arrangement of claim 2 wherein the first and second reclining seats are arranged to provide a double bed style configuration in the lie flat position.

4. The passenger seating arrangement of claim 1 wherein the first reclining seat and the second reclining seat of the seat units are independently moveable relative to each other between an upright position and a fully reclined position.

5. The passenger seating arrangement of any claim 4 wherein the plan view of the second reclining seat in the fully reclined position is a mirror image of the first reclining seat in the fully reclined position.

6. The passenger seating arrangement of claim 1 wherein the second reclining seat of the seat units is located closer to the aisle than the first reclining seat, the difference in the distance to the aisle being defined by the angle of the seat unit to the aisle.

7. The passenger seating arrangement of claim 1 wherein the first and second reclining seats are arranged in a substantially parallel configuration in the seat unit.

8. The passenger seating arrangement of claim 1 wherein the first and second passenger seats are modestly angled relative to each other in the seat unit, the maximum angle between the seats being 25 degrees.

9. The passenger seating arrangement of claim 1, wherein the angle between the seat units and the aisle measured as an angle between the centre line between the two reclining seats and the centre line of the longitudinal aisle is 20-50 degrees, preferably 30-50 degrees.

10. The passenger seating arrangement of claim 1, wherein the seat units in a column of staggered seat units comprising the first and second reclining seats are nestled.

11. The passenger seating arrangement of claim 1, comprising a separate egress for each of the first and second seats of the angled seat units for the direct access to the aisle.

12. The passenger seating arrangement of claim 11, wherein the seat units comprise doors in the separate egresses for to the first and second reclining seats.

13. The passenger seating arrangement of claim 1, comprising a shared egress for the first and second reclining seats of the seat units for access to the aisle.

14. The passenger seating arrangement of claim 1, wherein shape of at least one corner of the first or second reclining seat is formed depending on the positioning of the seat units relative to the cabin walls and/or the aisle.

15. The passenger seating arrangement of claim 1, wherein two successive seat units in a column are about normal relative to each other.

16. The passenger seating arrangement of claim 15, wherein the seat units form a group seating area.

17. The passenger seating arrangement of claim 15, comprising a moveable divider between two seat units.

18. The passenger seating arrangement of claim 15, configured to provide direct access between the two successive seat units without need to enter the aisle.

19. A passenger seating arrangement for an aircraft cabin, comprising a plurality of seat units each comprising at least a first reclining seat and a second reclining seat and located adjacent to a longitudinal aisle of the aircraft cabin, wherein the first reclining seat and the second reclining seat of the seat units are configured to have substantially similar plan view contour and side-by-side alignment when similarly reclined, the seat units are angled to the aisle to provide access from the aisle to the first and second reclining seats of the seat units, and the seat units are in a configuration where two successive seat units in a column are about normal relative to each other.

20. The passenger seating arrangement of claim 21 comprising four seat units arranged in about a X-shaped configuration to provide a group seating area.

21. A passenger seating arrangement for an aircraft cabin, comprising four seat units located adjacent to a longitudinal aisle of the aircraft cabin, wherein two seat units are in a first column and two seat units are in a second column, each seat unit comprises at least one reclining seat, the seat units are angled to the aisle to provide access from the aisle to the at least one reclining seat of the seat units, and the four seat units are arranged substantially in X-shaped configuration to provide a group seating area.

22. (canceled)

23. (canceled)

24. The passenger seating arrangement of claim 1, comprising a hanging partition configured for flexible operation between a closed position and a stowed position.

25. The passenger seating arrangement of claim 1, comprising at least one moveable monitor configured for turning between a substantially portrait display orientation and a substantially landscape display orientation.

26. (canceled)

27. (canceled)
